(19) United States
(12) Patent Application Publication
(10) Pub. No.: US 2026/0069966 A1
(43) Pub. Date: Mar. 12, 2026

(54) A METHOD FOR CONTROLLING A GAMING PEDAL

(71) Applicant: GRANITE DEVICES OY, Tampere (FI)

(72) Inventors: Iiro LEINO, Vesilahti (FI); Jani HILLIAHO, Tampere (FI); Lassi HÄMÄLÄINEN, Tampere (FI)

(21) Appl. No.: 19/108,920

(22) PCT Filed: Sep. 6, 2023
(86) PCT No.: PCT/FI2023/050509

§ 371 Date: Mar. 5, 2025

(30) Foreign Application Priority Data
Sep. 8, 2022 (FI) 20225779

(51) Int. Cl. A63F 13/22; A63F 13/245; A63F 13/285; A63F 13/803; G06F 3/01; G06F 3/033; G06F 3/04845; G06F 3/04847

(52) U.S. Cl. CPC A63F 13/22; A63F 13/245; A63F 13/285; A63F 13/803; G06F 3/016; G06F 3/0334; G06F 3/04845; G06F 3/04847; G06F 2203/013

(57) ABSTRACT

A gaming pedal comprises an electric actuator (13) that is configured to move the pedal as a response to a user depressing the pedal. A push arm (15) connects the electric actuator (13) to the pedal. The push arm (15) is rotatably coupled from both ends, and it is in acute angle to a screw shaft of the electric actuator (13). The system runs through computer-controlled loop where the force of the user depressing the pedal is measured by a load cell (14) integrated into the push arm (15). A control algorithm provides power to the electric actuator (13). A user interface illustrates the pedal counterforce as a graph on a display, as a resistance profile graph (2). The graph is adjusted by user interface objects (1), such as handles that the user may grab while adjusting the graph (2). The graph (2) illustrates the force (F) applied to the pedal arm (10) as a function (X) of a pedal arm travel. The user interface objects (1), or handles, may be quickly dragged by the user.

### BACKGROUND

Gaming pedals are purposed for controlling computer games or computer simulators by user's foot. One important aspect of the gaming pedal is to provide sense of authentic operation, for example by means for creating a counterforce to the pedal. One example is a force feedback pedal. The gaming pedal functions as a physical computer peripheral that can be used as an interface between the computer and the user. Gaming pedals are often used to simulate the operation of pedal controls in a real vehicle, such as an automobile, a watercraft, or an aircraft.

Car racing simulators typically include clutch, brake and throttle pedals. In one example, the gaming pedals and a steering wheel are mounted on a rig. The rig may be modifiable according to user's preferences, to provide a comfortable driving position. Each of the pedals, clutch, brake and throttle, provide different physical counterforce to the user in real cars-the gaming pedals should be able to provide similar sense of feeling to the user. Also, the pedal dynamics may be different from car to car. The simulator rigs may benefit from compact size, as they are often used in home environment with limited space. Compact size enables also more alternative placements for the pedals.

The pedal dynamics may correspond to values set by the user. For example the user may set a numeric value for a spring to correspond the pedal resistance, when the user depresses the pedal. It is known to apply the numerical values to a table representing the pedal dynamics and/or the pedal counterforce. Setting up the pedal dynamics via numerical values may be difficult for the user.

The user should be able to know the effect of modifications made to active pedal dynamics. In some examples, similar gaming pedals may be used for multiple purposes, wherein the user may need a tool for assigning different pedal dynamics.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for controlling the gaming pedal is disclosed hereinafter. The gaming pedal comprises an electric actuator that is configured to move the pedal as a response to a user depressing the pedal. A push arm connects the electric actuator to the pedal. The push arm is rotatably coupled from both ends, and it is in acute angle to a screw shaft of the electric actuator. The system runs through computer-controlled loop where the force of the user depressing the pedal is measured by a load cell integrated into the push arm. A control algorithm provides power to the electric actuator.

Having the electric actuator for providing the counterforce, without any return springs, allows assigning various counterforce or resistance profiles and haptic effects to the pedal. The same pedal structure may be used for simulating clutch, brake or throttle pedals. The counterforce or resistance may be applied either way, to resemble disengaging the clutch or depressing brake pedal. Any simulated haptic effect, such as engine vibrations, suspension vibrations, collisions, wheel spins or wheel lock ups may be felt on the pedal. The gaming pedal may be used as an active force feedback pedal. The gaming pedal travel, counterforce or pedal effects are fully customisable.

A user interface illustrates the pedal counterforce as a graph on a display, as a resistance profile graph. The graph is adjusted by user interface objects, such as handles that the user may grab while adjusting the graph. The graph illustrates the force applied to the pedal arm as a function of a pedal arm travel. The user interface objects, or handles, may be quickly dragged by the user. The user may drag the user interface objects by a computer mouse, by a finger on a touchscreen or by any other control peripheral that allows two-dimensional interaction with the graph.

The user interface may reflect the change in real-time, as the user changes the profile the effect may be felt immediately on the pedal. The haptic effects may be combined with the resistance profile. The simple visualization and user interface objects allow the user to modify the resistance profiles safely.

Many of the attendant features will be more readily appreciated as they become better understood by reference to the following detailed description considered in connection with the accompanying drawings. The embodiments described below are not limited to implementations which solve any or all the disadvantages of methods for controlling gaming pedals.

### BRIEF DESCRIPTION OF THE DRAWINGS

The present description will be better understood from the following detailed description read in light of the accompanying drawings, wherein

FIG. 1 illustrates schematically an isometric view of one example of a gaming pedal with a cover housing;

FIG. 2 illustrates schematically a side view of the same embodiment without the cover housing;

FIG. 3 illustrates schematically a side view with a reversed connection member;

FIG. 4 illustrates schematically a top side view of the embodiment of FIG. 2;

FIG. 5 illustrates schematically a front side view of one example of a gaming pedal;

FIG. 6 illustrates schematically a side view of one example of the gaming pedal;

FIG. 7 illustrates schematically a side view of one example of the gaming pedal;

FIG. 8 illustrates one exemplary embodiment of a resistance profile assigned to the pedal;

FIG. 9 illustrates one exemplary embodiment of the resistance profile with one exemplary haptic effect;

FIG. 10 illustrates schematically one exemplary embodiment of a user interface for modifying a resistance profile graph;

FIG. 11 illustrates schematically a first step of one exemplary embodiment of the user interacting with the resistance profile graph;

FIG. 12 illustrates schematically a second step of one exemplary embodiment of the user interacting with the resistance profile graph;

FIG. 13 illustrates schematically a third step of one exemplary embodiment of the user interacting with the resistance profile graph;

FIG. 14 illustrates schematically one exemplary embodiment of the user interface for modifying the resistance profile graph;

FIG. 15 illustrates schematically one exemplary embodiment of the user interface for modifying the resistance profile graph;

FIG. 16 illustrates schematically one exemplary embodiment of the user interface for modifying the resistance profile graph; and

FIG. 17 illustrates schematically one exemplary embodiment of the user interface for modifying the resistance profile graph;

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples are described and illustrated herein as being implemented in a pedal for racing simulators, the device or the method described are provided as an example and not a limitation. As those skilled in the art will appreciate, the present examples are suitable for application in a variety of different types of vehicle simulation systems and gaming applications.

Aspects of this disclosure relate to a gaming pedal that can be used in conjunction with a number of software applications, which can typically include vehicle simulators, such as automobile, naval vessel, and aircraft simulators. One exemplary embodiment relates to automotive racing simulators or racing games. A gaming pedal system may comprise multiple gaming pedals, such as a clutch, a brake or a throttle. Each pedal may provide a realistic counterforce profile that simulates the sense of how a real pedal feels when depressed by a user. The counterforce profile may be modifiable. The gaming pedal disclosed hereinafter may be used as a clutch pedal, a brake pedal or a throttle pedal.

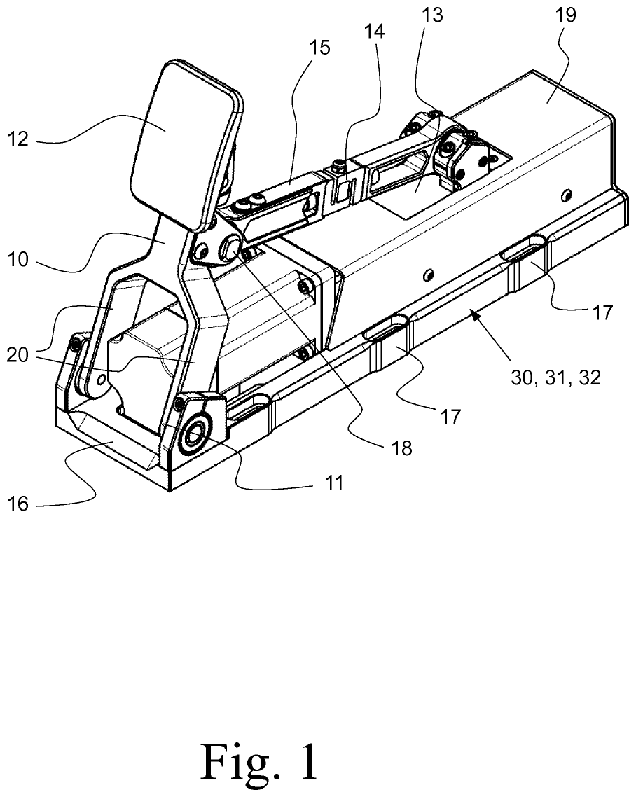

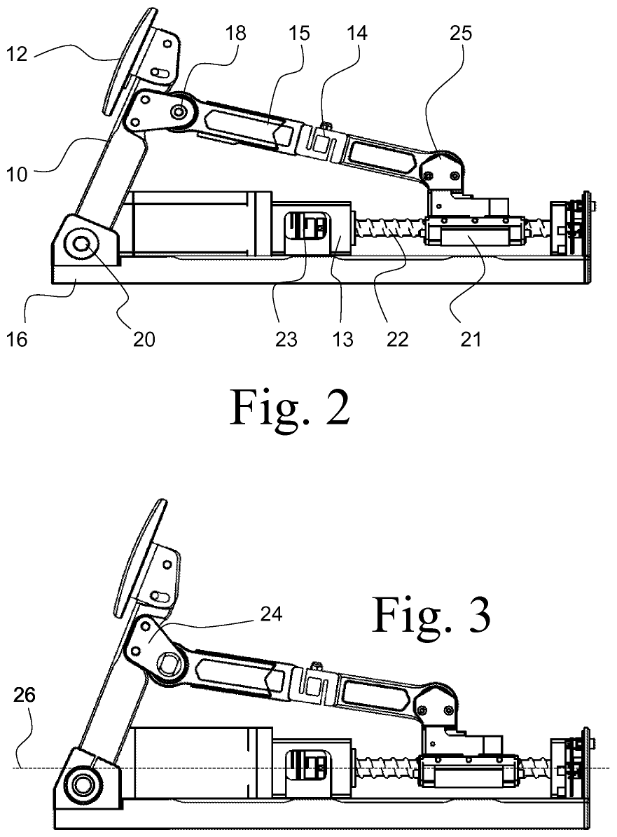

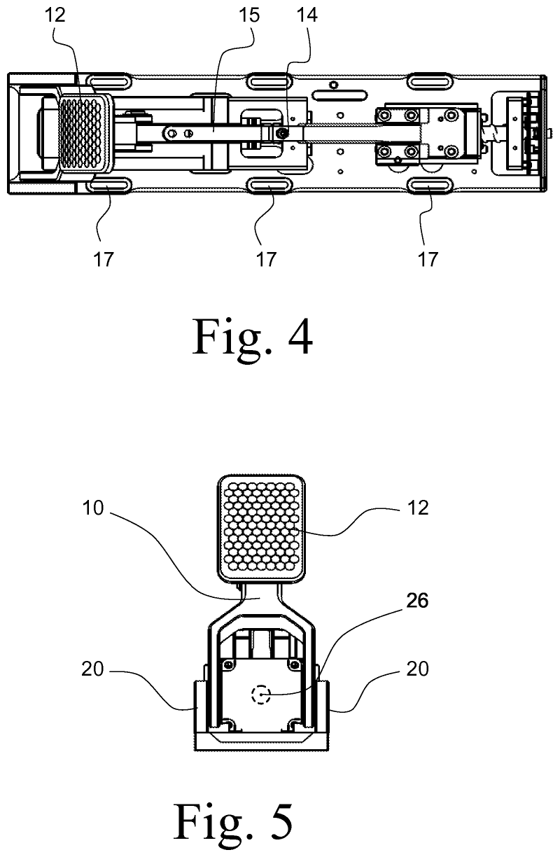

FIG. 1 illustrates schematically an isometric view of one example of a gaming pedal. The gaming pedal comprises a cover housing 19 hiding some of the internal components. FIG. 2 illustrates schematically a side view of the same embodiment without the cover housing 19. FIG. 4 illustrates schematically a top side view of the same embodiment. The gaming pedal comprises a base 16 that supports the functional components. The base 16 may be coupled to a rig via attachment holes 17. The rig may hold several pedals, steering wheel, seat and/or other peripherals or devices used with the simulation. In this context directions, such as up, down, horizontal, vertical, etc., are described in reference to a gravity and user's position, where for example the base 16 is at the bottom of the gaming pedal.

A pedal arm 10 is rotatably coupled to the base 16 from a first end 11. The coupling is in one exemplary embodiment a rotatable coupling, such as a hinge that provides an axis of rotation for the pedal arm 10 relative to the base 16. The second end of the pedal arm 10 comprises a user interface region, such as a pedal surface 12 coupled to the pedal arm 10. The user operates the gaming pedal by depressing the pedal surface 12.

An electric actuator 13 is configured to move the pedal arm 10. In the present embodiment the electric actuator 13 is a linear actuator. The electric actuator 13 comprises a slide block 21, a screw shaft 22 and an electric motor 23 configured to rotate the screw shaft 22. In one embodiment the electric actuator 13 comprises a ball screw. In one embodiment the electric actuator 13 comprises a lead screw. In one embodiment the screw shaft is positioned parallel to the base 16.

A push arm 15 is arranged between the slide block 21 and the pedal arm 10 to transfer the movement between the pedal arm 10 and the electric actuator 13. A first end of the push arm 15 is rotatably coupled to the pedal arm 10 to a position between the first end 11 and the second end of the pedal arm 10. In one embodiment, the first end of the push arm 15 is coupled to the pedal arm 10 via a first revolute joint 18. A second end of the push arm 15 is rotatably coupled to the slide block 21. In one embodiment, the second end of the push arm 15 is coupled to the slide block 21 via a second revolute joint 25. The first end of the push arm 15 is positioned higher than the second end. The gaming pedal operates on active electric actuator 13 providing resistance to the user's foot. The system is prone to oscillate or to create unwanted vibrations. As the push arm is rotatably coupled from its both ends, only one force vector will be measured from the push arm.

Between the push arm 15 and the screw shaft 22 is an acute angle. In one embodiment, the angle is between 10 and 40 degrees. The angle changes according to the slide block 21 movements on the screw shaft 22. The push arm 15 is configured to transfer the force of the electric actuator 13 to the pedal arm 10. The angled push arm 15 provides improvements in the compactness of the gaming pedal.

In one embodiment, the first end of the pedal arm 10 comprises an inverted Y-shaped structure, having two rotatable couplings 20 at opposite sides of the base 16. An imaginary rotational axle 26 of the screw shaft 22 extends between the pedal arm 10. FIG. 5 illustrates schematically a front view of one example of a gaming pedal. The inverted Y-shaped structure contributes to the compactness of the gaming pedal. The electric actuator 13 and the pedal arm 10 are at the same level.

In one embodiment the maximum torque provided by the electric motor 23 is 5 Nm and a thread pitch of the screw shaft 22 is between 5 mm and 20 mm. In one embodiment the maximum torque provided by the electric motor 23 is 4 Nm and a thread pitch of the screw shaft 22 is 10 mm. Maximum rotational speed of the electric motor 23 is 3.300 rpm. The configuration with the geometry according to FIG. 2 enables the pedal counterforce at the pedal surface 12 to exceed 1500 N. In one embodiment, the maximum pedal counterforce at the pedal surface 12 is 2000 N. The angled push arm 15, with the selection of said parameters causes the combinatory effect of compact size. The electric motor 23 of 4 N is configured to fit inside the housing of the electric actuator 13. In one embodiment, the electric motor 23 is a stepper motor providing information of the rotational position to the control system, and the position of the pedal surface 12. In one embodiment, the stepper motor provides 22-bit resolution.

A load cell 14 is configured to measure force applied to the pedal surface 12. In one exemplary embodiment, the load cell 14 is a strain gauge load cell. In one embodiment, the load cell is an S-type load cell. In one embodiment the load cell 14 is arranged in the middle portion of the push arm 15. In one embodiment, the load cell 14 is coupled to the push arm 15, between the first end and the second end of the push arm 15. In one embodiment, the load cell 14 is arranged between the pedal surface 12 and the pedal arm 10.

In one embodiment, a reversible connection member 24 is coupled to the pedal arm 10 via the first revolute joint 18. The reversible connection member 24 has two operating positions. FIG. 2 illustrates the first operating position, where the first revolute joint 18 is connected to the connection member 24 at a first distance from the first end of the push arm 15. The second operating position is illustrated in FIG. 3, where the first revolute joint 18 is connected to the connection member 24 at a second distance from the first end of the push arm 15. Reversing the connection member 24 allows the user to modify the geometry and the angle of the push arm 15. This modifies the counterforce provided by the electric actuator 13, the counterforce profile and/or the response felt by the user when depressing the pedal.

The gaming pedal comprises at least one processor 30 and a memory 31 storing instructions that, when run on the processor, cause the gaming pedal to operate as a computer peripheral. The gaming pedal comprises a transceiver 32 configured to provide a communication link between the gaming pedal and the computer providing the simulator system, providing the gaming service or running the simulation. In one embodiment, the transceiver 32 is configured to provide the communication link between the sensors and the components of the gaming pedal, the gaming pedal system comprising multiple pedals or a control system configured to manage components mounted onto the simulator rig. The system may comprise multiple transceivers 32. In one embodiment, the transceiver 32 provides a wireless link, provided to communicate by wireless protocol such as Bluetooth or Wi-Fi. In one embodiment, the transceiver 32 provides a communication protocol such as CAN bus or Ethernet. Ethernet protocol enables fast internal communication of the simulator system and the gaming pedal to prevent unwanted harmonic oscillations or vibrations.

The load cell 14 provides to the processor 30 information of the force applied to the pedal surface 12, or any other force that is applied to the load cell 14. The electric actuator 13 provides to the processor 30 information about the position of the pedal surface 12. The simulation software provides to the processor the simulation data, for example the control data of the current situation that is being simulated. The processor 30 calculates according to the provided data a drive voltage for the electric motor 23. The electric motor 23 provides force to the pedal surface 12, which is again measured by the load cell 14. The control loop is run continuously, while checking all basic parameters during each loop. This provides a synchronized multichannel measurement and control for the gaming pedal. The control algorithm is in one embodiment a PID controller (PID, proportional-integral-derivative) that calculates an error value as the difference between a desired force and a measured force and applies a correction based on proportional, integral, and derivative terms. In one embodiment the control algorithm is a modified PID algorithm.

In one embodiment, the at least one processor 30 and the memory 31 storing instructions that, when executed, cause the electric actuator 13 to provide a first force simulating automotive pedal resistance according to a resistance profile and at least one second force providing a haptic effect on the pedal. The first force is applied as the fundamental response and counterforce of the gaming pedal, a first force vector. The second force is a force parameter that is added to the first force vector as a second force vector.

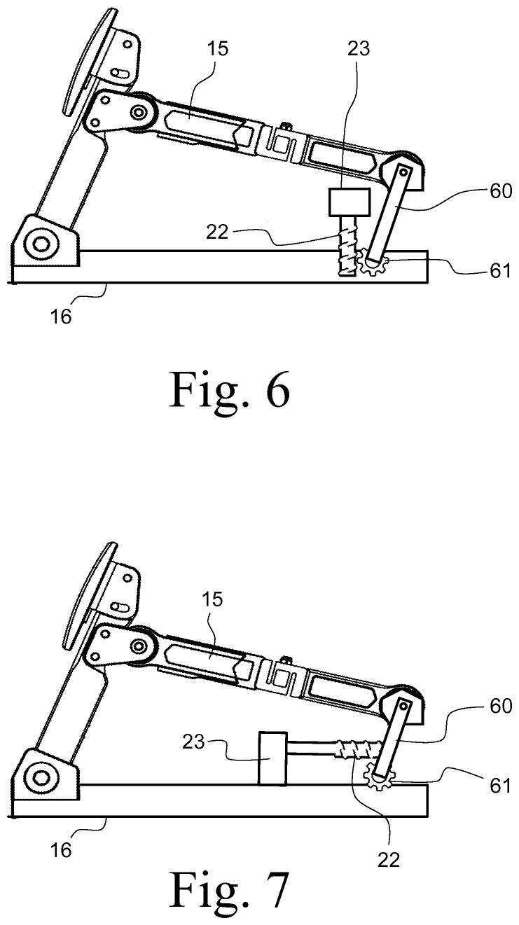

FIG. 6 illustrates schematically a side view of one example of the gaming pedal. In this embodiment, the screw shaft 22 is positioned vertically, transversely to the base 16. The electric motor 23 is in line with the screw shaft 22, configured to rotate the screw shaft 22. The electric actuator is in this embodiment a rotary actuator. The screw shaft 22 is in contact with a pinion 61 that is configured to rotate in response to the electric motor 23 rotating the screw shaft 22. The gear ratio on the screw shaft 22 and the pinion 61 allows selecting a compact-sized electric motor 23, that will provide the required amount of torque. A lever arm 60 is fixedly coupled to the pinion 61 and rotatably coupled to the push arm 15. The lever arm 60 transfers the rotational movement of the electric motor 23 to the push arm 15, providing movement and thereby resistance for the gaming pedal.

FIG. 7 illustrates schematically a side view of one example of the gaming pedal. In this example the arrangement of the previous example has been altered in that the screw shaft 22 is parallel to the base 16. The screw shaft 22 is coupled to the electric motor 23 and further in contact with the pinion 61 that is configured to rotate in response to the electric motor 23 rotating the screw shaft 22. The lever arm 60 is configured to move the push arm 15. The screw shaft 22 and the pinion 61 provide in the examples of FIG. 6 and FIG. 7 suitable gearing that allows using compact-sized electric motors 23. The sizes of the components in the Figures are only illustrative, they do not specify the actual dimensions of the gaming pedal components.

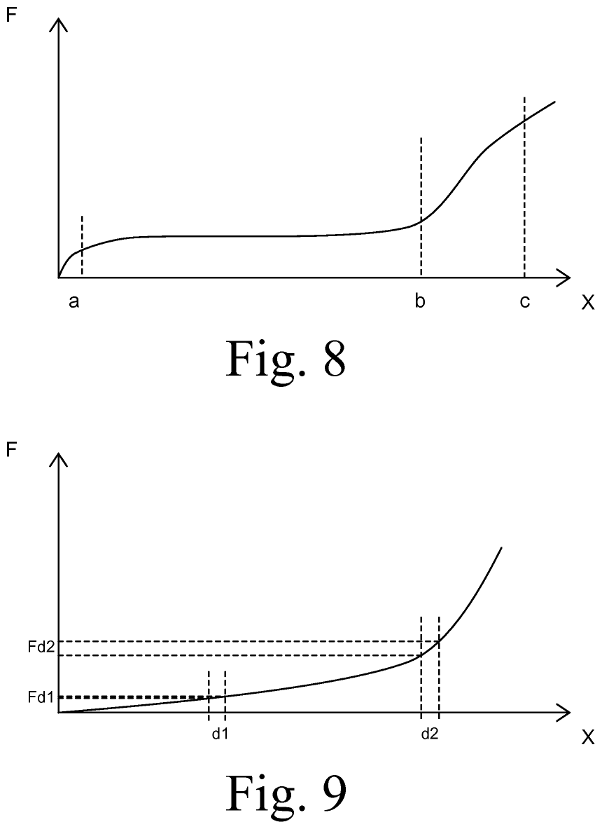

FIG. 8 illustrates schematically one example of the resistance profile, the resistant force F as a function of X, the travel of slide block 21. The travel of slide block 21 is related to the travel of the pedal surface 12. The example is from a throttle pedal, having fairly even resistant force throughout the travel of the pedal surface 12. The profile is divided into three zones, where line a denotes zone starting from the beginning of the travel. The first centimetres or millimetres of the travel—until position a—is not transmitted to the computer running the simulation software. The first zone may be called as “dead zone”—where small anomalies are filtered out. The feature also allows the user to rest foot lightly on the pedal when the throttle is no supposed to be used. The zone between lines a and b is the operational zone that is transmitted to the simulator. After line b start the overshoot zone, where the simulator receives information about 100% throttle, but the resistance of the pedal—as the user perceives it—increases rapidly. This allows the user to set the profile to desired operational range.

In one embodiment, the user may record the resistance profile from a real vehicle and store the profile into the memory 31. Setting the resistance profile allows simulating various vehicles and models. The user may perceive travel of the pedals being similar to real world counterparts, as the resistance is effected only by the electric motor 23. The resistance may be recorded by detecting the travel and the required force of the pedal. The recording may be done while driving the vehicle, incorporating possible vibrations or other movements into the recorded profile.

In one embodiment the haptic effect is an engine vibration wherein the second force is a variable force component proportional to the simulated engine revolutions. The second force is added to the first force. During the vibrations the force vector may vibrate between positive and negative values. The haptic feel for the user resembles real engine running. The effect may be present even without the user depressing the pedal. The vibrating gaming pedal conducts in some embodiments the vibration to the rig, where it may produce sounds. The user may sense the vibration through other components mounted to the rig—for example the seat or the steering wheel may vibrate slightly in response to the vibrating gaming pedal. The engine vibration effect is in one embodiment proportional to the force at which the user depresses the gaming pedal. For example, when the user brakes hard the user may feel a V8 engine rumble through the brake pedal. In one embodiment the engine vibration effect modulates the pedal basic function. The engine vibration may be present synchronously as the haptic effect at all pedals installed to the rig, as well as at the steering wheel or at a gearstick. The engine vibration may be adjusted according to the vehicle to be simulated: engine types such as V6, V8 or R4 have different vibration characteristics.

FIG. 9 illustrates one exemplary embodiment of the resistance profile with one exemplary haptic effect; the resistant force F is illustrated as a function of X, the travel of slide block 21. The travel of slide block 21 corresponds to the data received from the stepper motor. The example could be applied as a brake pedal resistance profile. In one example of modelling the engine vibrations in a real vehicle, the brake pedal is often hingedly coupled to the vehicle floor. The brake pedal surface of the real vehicle would receive the vibration via the brake pedal arm. The user would sense the vibration increasingly, as he/she applies more power to the brake pedal. In this example, the haptic effect is created by alternating the travel X in two exemplary positions, d1 and d2. Upon depressing the brake pedal lightly, as in the position d1, the brake pedal resistance profile rises slowly, and the corresponding force Fd1 is relatively small. Therefore, the vibration sensed by the user is relatively small at the brake pedal position d1. As the user depresses the brake pedal more, into position d2, the brake resistance, and the resistance profile, rises rapidly. The corresponding vibrating force Fd2 is stronger, therefore the uses senses more vibration by increasingly depressing the brake pedal.

In one embodiment the haptic effect is a clutch operation selected from a group of: clutch engaging to the biting point, clutch fully engaging, clutch disengaging from the biting point, clutch fully disengaging, clutch slipping, double-clutching. The clutch operation's first force resembles in one embodiment basic spring action. The clutch engaging, biting or slipping typically affects engine vibration. An experienced user may feel the clutch operation from the vehicle vibrations and/or sounds. Wheelspin may provide an additional vibration to the pedal. Alternatively, or in addition, the clutch pedal may feel lighter after the clutch has fully engaged.

In one embodiment the haptic effect is an ABS brake valve pulse or a vibration indicating a locking brake. The effect is provided as a vibration force vector to the brake pedal function.

In one embodiment the haptic effect is a pedal damping, where the pedal movement is slowed down. The pedal damping may be construed as gain to the pedal function. The pedal damping may operate in different manner when the pedal is depressed or released. The pedal damping may simulate viscous damping related to fluid-operated pedal systems, such as brakes.

In one embodiment the haptic effect is a pedal friction. The pedal friction may be construed as gain to the pedal function. The pedal friction may simulate pedal hinge friction or friction of the cables connected to the pedal, for example a throttle cable.

In one embodiment the haptic effect is a pedal hysteresis. The pedal hysteresis may be construed as gain to the pedal function or an algorithm following the operational position of the pedal. The pedal hysteresis may simulate brake pedal hysteresis caused by the pedal mechanism or brake hydraulics.

In one embodiment the haptic effect is game output adjustment, where the user may adjust the force required by the gaming pedal. The game adjustment may be executed by adjusting the resistance profile or numeric parameters presented to the user.

Alternatively, or in addition, the haptic effects may be related to dynamics of the vehicle to be simulated, or the telematic information received from the computer. The engine vibration is one example of dynamic haptic effects.

In one embodiment the haptic effect is a vehicle acceleration. The vehicle acceleration may be sensed in the gaming pedals by adjusting the pedal resting point, for example the fast accelerating race car may slightly move the gaming pedal resting position. The user may sense as immersive the pedals moving on their own as the simulated vehicle accelerates.

In one embodiment the haptic effect is change in the vehicle acceleration. The quick changes in the vehicle acceleration may be sensed as small jerks in the gaming pedal.

In one embodiment the haptic effect is change in the vehicle vibrations. The vehicle may vibrate for example due to terrain, tire choice, tire wear, damage or other common cause. In one embodiment, the vehicle vibration is passed as a sequence between adjacent pedals. For example, one micromovement may effect throttle pedal first, quickly followed by the brake pedal and the clutch pedal.

In one embodiment the haptic effect is vehicle drifting. The vehicle may drift for example due to excessive speed or throttle use. In one embodiment, the vehicle drifting is passed as a sequence between adjacent pedals. For example, one micromovement may effect throttle pedal first, quickly followed by the brake pedal and the clutch pedal. In simulation, vehicle drifting may affect rear wheels, front wheels or all four wheels.

In one embodiment the haptic effect is gear change. The vehicle may feel the gear change as a change in the acceleration or as a short burst of vibrations.

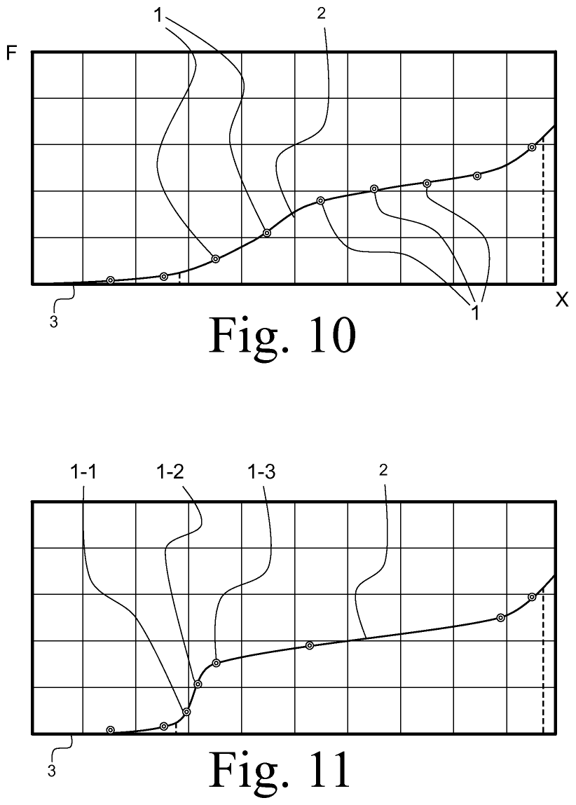

FIG. 10 illustrates schematically one exemplary embodiment of a user interface for modifying the resistance profile. The embodiment relates to the device for controlling the gaming pedal as disclosed hereinbefore. The method comprises displaying, on a display 3, a user interface that includes a plurality of user interface objects 1. The display 3 is in one example a computer screen, wherein the computer is running the simulator program, for example the racing game. In one embodiment, the display 3 is connected to the control system configured to manage components mounted onto the simulator rig. The control system may be running in the same computer that is running the simulator program or the control system may be a stand-alone system having a data connection to the simulator system. In one example the display 3 is a touch sensitive display, for example a tablet computer display. The display 3 may be a portion of the computer screen, wherein other portions may display other information. The axis notations F and X may not be visible on the display 3.

A resistance profile graph 2 travels via the plurality of user interface objects 1. In the illustration, the user interface objects 1 are depicted as round objects, but they may comprise any suitable shape to differentiate the user interface object from the resistance profile graph 2. Each respective user interface object 1 is associated with a portion of a resistance profile graph 2 illustrating a first resistant force F as a function of a travel X of the electric actuator 13. In this context, a graph relates to graph of a function, where each value of X relates to one value of F.

The method comprises detecting, via one or more input devices, an input that corresponds to a request to reposition at least one user interface object 1. For example, the user may grab onto the user interface object 1 by a computer mouse or by the touch screen interface. In response to detecting the input, the method comprises repositioning the user interface object 1. For example, the user moves the grabbed interface object 1. In a further step, a revised path for the resistance profile graph 2 is calculated via the plurality of the user interface objects 1. A repositioned resistance profile graph 2 is displayed on the display 3. In one example, the user changes the resistance profile graph 2 by moving one user interface object 1, or multiple user interface objects 1. In one embodiment, the user may mark multiple user interface objects 1 to be moved simultaneously.

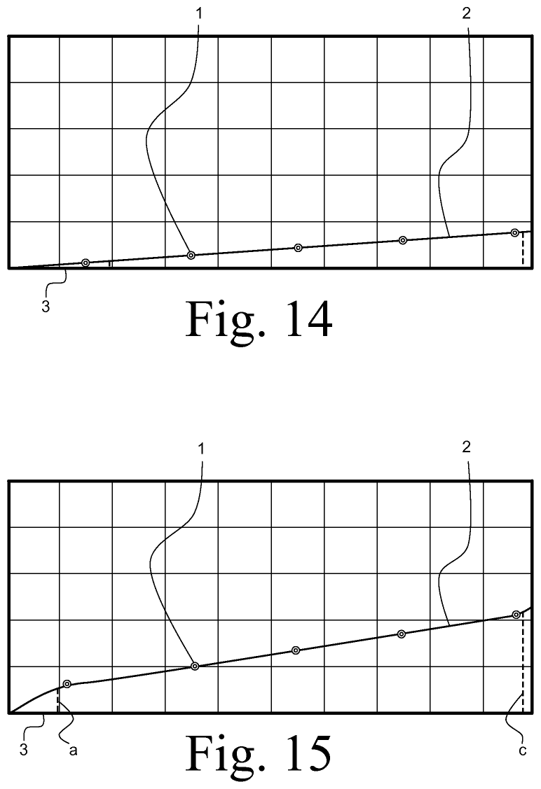

FIG. 14 illustrates schematically one exemplary embodiment of the user interface for modifying the resistance profile graph 2. In this example, the resistance profile graph 2 is linear. The user may grab simultaneously all user interface objects 1, and modify the resistance profile graph to the example of FIG. 15, where the graph is linear between all the user interface objects 1. In one exemplary embodiment, the slope of the resistance profile graph 2 is adjusted by a scroll wheel of the computer mouse. Rotating the scroll wheel to first direction may increase the slope and rotating the scroll wheel to second direction may decrease the slope. The first zone a and the third zone c may comprise curved portions, that do not affect to the functionality of the gaming pedal.

In one embodiment, the method comprises smoothing the resistance profile graph 2 by a basis spline, when calculating the path for the resistance profile graph 2 via the plurality of the user interface objects 1. Basis spline, or B-spline, is a spline function that has minimal support with respect to a given degree, smoothness, and domain partition. The smoothing removes hard edges from the resistance profile graph. FIG. 10 illustrates one example of the smoothed resistance profile graph 2.

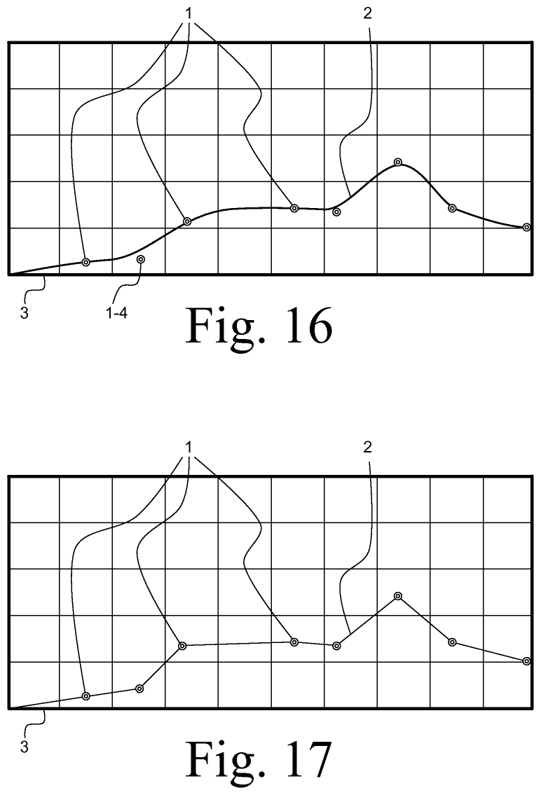

In one embodiment, the method comprises smoothing the graph 2 by at least one function from a group of: Butterworth filter, Chebyshev filter, exponential smoothing, Kalman filter, Kernel smoother, Kolmogorov-Zurbenko filter, local regression, moving average, Ramer-Douglas-Peucker algorithm and Savitzky-Golay filter. In one embodiment, the method comprises combining multiple smoothing functions. FIG. 16 illustrates one example of the smoothed resistance profile graph 2, where the smoothing causes at least one user interface object 1-4 to appear separate from the resistance profile graph 2. The user interface object 1-4 causes a curve to the resistance profile graph 2. In some embodiments, the user interface objects 1 may not touch the resistance profile graph 2 due to the smoothing function. The user interface objects 1 may vary in size, in the form it is illustrated in the display 3. The resistance profile graph 2 does not need to pass through the visualized user interface object 1.

In one embodiment, the method comprises drawing a straight line between laterally adjacent user interface objects 1, when calculating the path for the resistance profile graph 2 via the plurality of the user interface objects 1. The resistance profile graph 2 itself may comprise different shapes. FIG. 17 illustrates schematically one exemplary embodiment of the resistance profile graph 2 with straight lines between the user interface objects 1.

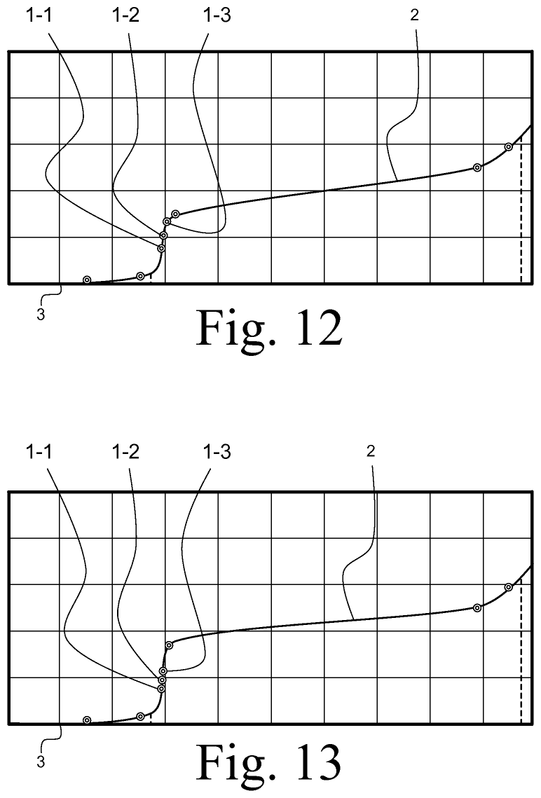

FIG. 11 illustrates schematically one exemplary embodiment of user interaction with the user interface objects 1-1, 1-2 and 1-3. FIG. 12 and FIG. 13 illustrate further steps of the user interface objects 1-1, 1-2 and 1-3, when moved by the user. In these examples, notation 1-1, 1-2 or 1-3 refers to user interface objects 1 in the order of the example.

In one embodiment, moving at least one first user interface object 1-1 sideways to a portion of a resistance profile graph 2, associated with laterally adjacent second user interface object 1-2, causes the first user interface object 1-1 and the second user interface object 1-2 to stack vertically. The direction in which the laterally adjacent user interface objects 1-1 and 1-2 stack vertically depends on the direction of the resistance profile graph 2. Pulling the adjacent user interface objects 1-1 and 1-2 together causes to slope to increase or decrease.

In one embodiment, after stacking the first user interface object 1-1 and the second user interface object 1-2 vertically, the first user interface object 1-1 and the second user interface object 1-2 are each associated to laterally opposite portion of the resistance profile graph 2 compared to the laterally adjacent user interface object 2. If two adjacent user interface objects 1-1 and 1-2 are pulled together, the effect on the smoothing function decreases as the distance between adjacent user interface objects 1-1 and 1-2 diminishes. The effect may be calculated according to the smoothing function.

In one embodiment, after stacking three user interface objects 1-1, 1-2 and 1-3 vertically, the user interface object 1-2 having been in the middle has no associated portion of the resistance profile 2. In one embodiment, the user interface object 1-2 in the middle may merge with one of the adjacent user interface objects 1-1 or 1-3.

In one embodiment, the method comprises assigning a first zone “a” to the beginning portion of the travel of the electric actuator 13 that does not produce a signal to the simulator system. One example of the first zone a is illustrated in FIG. 8. The “dead zone” may provide additional filtering against signal noise that could be felt on the pedal.

In one embodiment, the method comprises assigning a third zone “c” to the end portion of the travel of the electric actuator 13 that produces a 100% signal to the simulator system; and a second zone a-c before the third zone c, where the travel of the electric actuator 13 corresponds to the signal produced to the simulator system. The third zone c corresponds to overshoot range of the gaming pedal, where the electric actuator 13 applies full torque. The third zone prevents the user from, or mitigates the possibility of depressing the gaming pedal to its mechanical limit.

In one embodiment, the method comprises moving the electric actuator 13 in response to detecting the input that corresponds to a request to reposition at least one user interface object 1, wherein the movement corresponds to the revised path for the resistance profile graph 2 via the plurality of the user interface objects 2. The user may sense the changes in the resistance profile graph 2 while operating the user interface object 1.

In one embodiment, the method comprises generating a vibration to test the gaming pedal in response to detecting the input that corresponds to a test request. The user may test the system via the user interface and the gaming pedal responds by haptic effect, for example by vibration.

A method for controlling a gaming pedal is disclosed herein. The pedal comprises a base; a pedal arm having a first end rotatably coupled to the base; a pedal surface coupled to the pedal arm; an electric actuator moving the pedal arm; a load cell measuring force applied to the pedal surface. The method comprises the steps of providing, by the electric actuator, a first resistant force simulating pedal resistance when a user is depressing the pedal surface; displaying, on a display, a user interface that includes a plurality of user interface objects, wherein a respective user interface object is associated with a portion of a resistance profile graph illustrating the first resistant force as a function of a travel of the electric actuator and the resistance profile graph travels via the plurality of user interface objects; detecting, via one or more input devices, an input that corresponds to a request to reposition at least one user interface object; in response to detecting the input, repositioning the user interface object; calculating a revised path for the resistance profile graph via the plurality of the user interface objects; and displaying a repositioned resistance profile graph. In one embodiment, when calculating the path for the resistance profile graph via the plurality of the user interface objects, the method comprises smoothing the graph by a basis spline. In one embodiment, when calculating the path for the resistance profile graph via the plurality of the user interface objects, the method comprises drawing a straight line between laterally adjacent user interface objects. In one embodiment, when calculating the path for the resistance profile graph via the plurality of the user interface objects, the method comprises smoothing the graph by at least one function from a group of: Butterworth filter, Chebyshev filter, exponential smoothing, Kalman filter, Kernel smoother, Kolmogorov-Zurbenko filter, local regression, moving average, Ramer-Douglas-Peucker algorithm and Savitzky-Golay filter. In one embodiment, the method comprises moving at least one first user interface object sideways to a portion of a resistance profile graph associated with laterally adjacent second user interface object causes the first user interface object and the second user interface object to stack vertically. In one embodiment, in the method, after stacking the first user interface object and the second user interface object vertically, the first user interface object and the second user interface object are each associated to laterally opposite portion of the resistance profile graph compared to the laterally adjacent user interface object. In one embodiment, in the method, after stacking three user interface objects vertically, the user interface object having been in the middle has no associated portion of the resistance profile. In one embodiment, the method comprises assigning a first zone to the beginning portion of the travel of the electric actuator that does not produce a signal to the simulator system. In one embodiment, the method comprises assigning a third zone to the end portion of the travel of the electric actuator that produces a 100% signal to the simulator system; and a second zone before the third zone, where the travel of the electric actuator corresponds to the signal produced to the simulator system. In one embodiment, the method comprises moving the electric actuator in response to detecting the input that corresponds to a request to reposition at least one user interface object, wherein the movement corresponds to the revised path for the resistance profile graph via the plurality of the user interface objects. In one embodiment, the method comprises generating a vibration to test the gaming pedal in response to detecting the input that corresponds to a test request. In one embodiment, the method comprises adjusting a slope of the resistance profile graph 2 by a scroll wheel of a computer mouse.

Alternatively, or in addition, herein is disclosed a computer readable storage medium storing one or more programs, the one or more programs comprising instructions, which when executed by an electronic device with a display, causes the device to perform any of the methods as disclosed hereinbefore.

Alternatively, or in addition, herein is disclosed a device, comprising a processor and a memory storing instructions that, when executed on the processor, cause the device to perform any of the methods of claims as disclosed hereinbefore.

Alternatively, or in addition, the controlling functionality described herein can be performed, at least in part, by one or more hardware components or hardware logic components. An example of the gaming pedal described hereinbefore is a computing-based device comprising one or more processors which may be microprocessors, controllers or any other suitable type of processors for processing computer executable instructions to control the operation of the device in order to control one or more sensors, receive sensor data and use the sensor data. The computer executable instructions may be provided using any computer-readable media that is accessible by computing based device. Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device it will be appreciated that the storage may be distributed or located remotely and accessed via a network or other communication link, for example by using communication interface.

The apparatus or the device may comprise an input/output controller arranged to output display information to a display device which may be separate from or integral to the apparatus or device. The input/output controller is also arranged to receive and process input from one or more devices, such as a user input device (e.g. a mouse, keyboard, camera, microphone or other sensor).

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not only include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Any range or device value given herein may be extended or altered without losing the effect sought.

Although at least portion of the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method for controlling a gaming pedal, said pedal comprising:
a base;
a pedal arm having a first end rotatably coupled to the base;
a pedal surface coupled to the pedal arm;
an electric actuator moving the pedal arm;
a load cell measuring force applied to the pedal surface and
providing, by the electric actuator a first resistant force simulating pedal resistance when a user is depressing the pedal surface,
characterized by:
displaying, on a display, a user interface that includes a plurality of user interface objects, wherein a respective user interface object is associated with a portion of a resistance profile graph illustrating the first resistant force as a function of a travel of the electric actuator and the resistance profile graph travels via the plurality of user interface objects;
detecting, via one or more input devices, an input that corresponds to a request to reposition at least one user interface object;
in response to detecting the input, repositioning the user interface object;
calculating a revised path for the resistance profile graph via the plurality of the user interface objects; and
displaying a repositioned resistance profile graph.

2. A method according to claim 1, characterized in that, when calculating the path for the resistance profile graph via the plurality of the user interface objects, the method comprises smoothing the resistance profile graph by a basis spline.

3. A method according to claim 1, characterized in that, when calculating the path for the resistance profile graph via the plurality of the user interface objects, the method comprises drawing a straight line between laterally adjacent user interface objects.

4. A method according to claim 1, characterized in that, when calculating the path for the resistance profile graph via the plurality of the user interface objects, the method comprises smoothing the resistance profile graph by at least one function from a group of: Butterworth filter, Chebyshev filter, exponential smoothing, Kalman filter, Kernel smoother, Kolmogorov-Zurbenko filter, local regression, moving average, Ramer-Douglas-Peucker algorithm and Savitzky-Golay filter.

5. A method according to claim 1, characterized in that moving at least one first user interface object sideways to a portion of a resistance profile graph associated with laterally adjacent second user interface object causes the first user interface object and the second user interface object to stack vertically.

6. A method according to claim 5, characterized in that after stacking the first user interface object and the second user interface object vertically, the first user interface object and the second user interface object are each associated to laterally opposite portion of the resistance profile graph compared to the laterally adjacent user interface object.

7. A method according to claim 6, characterized in that after stacking three user interface objects vertically, the user interface object having been in the middle has no associated portion of the resistance profile.

8. A method according to claim 1, characterized by assigning a first zone (a) to the beginning portion of the travel of the electric actuator that does not produce a signal to the simulator system.

9. A method according to claim 1, characterized by assigning a third zone (c) to the end portion of the travel of the electric actuator that produces a 100% signal to the simulator system; and a second zone before the third zone (c), where the travel of the electric actuator corresponds to the signal produced to the simulator system.

10. A method according to claim 1, characterized by moving the electric actuator in response to detecting the input that corresponds to a request to reposition at least one user interface object, wherein the movement corresponds to the revised path for the resistance profile graph via the plurality of the user interface objects.

11. A method according to claim 1, characterized by generating a vibration to test the gaming pedal in response to detecting the input that corresponds to a test request.

12. A method according to claim 1, characterized by adjusting a slope of the resistance profile graph by a scroll wheel of a computer mouse.

13. A computer readable storage medium storing one or more programs, the one or more programs comprising instructions, which when executed by an electronic device with a display, causes the device to perform the method of claim 1.

14. A device, comprising a processor and a memory storing instructions that, when executed on the processor, cause the device to perform the method of claim 1.
